(19) United States
(12) Patent Application Publication
(10) Pub. No.: US 2008/0211889 A1
(43) Pub. Date: Sep. 4, 2008

(54) INK STORAGE MODULE FOR STORING REMNANT INK OF AN INK JET DEVICE

(76) Inventors: Chern-Shi Lam, Batu Pahat (MY); Yen-Sung Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/971,916

(22) Filed: Jan. 10, 2008

(30) Foreign Application Priority Data
Jan. 10, 2007 (TW) 096100938

(51) Int. Cl. B41J 2/175

(52) U.S. Cl. 347/86

(57) ABSTRACT

An ink storage module includes a base, a clamping structure, a pipeline, and a blotting structure. The clamping structure is connected to the base to create a monolithic structure. The clamping structure has at least one ink outlet. An end of the pipeline is connected to a pump for receiving remnant ink pumped by the pump, and another end of the pipeline is connected to the clamping structure in a detachable manner for conveying the remnant ink into the clamping structure. The blotting structure is installed on the base and is disposed at a side of the ink outlet for absorbing the remnant ink.

### BACKGROUND OF THE INVENTION

1. Field of the Invention

The present invention relates to an ink storage module, and more specifically, to an ink storage module for storing remnant ink of an ink jet device.

2. Description of the Prior Art

With improvement of technology, ink jet devices have attained wide application in a variety of office machines, such as printers, faxes, and scanners. An ink gun of an ink jet device must be cleaned regularly to make sure that it can work properly. This is because remnant ink usually collects at an ink outlet of the ink gun when the ink jet device has been used for a period of time. If ignored, the remnant ink will affect performance of the ink gun as time passes. Therefore, even when the ink jet device is not printing, the cleaning process for the ink gun is still performed regularly. Ink cleaned from the ink gun is retrieved and stored by the ink jet device after cleaning.

A common method for retrieving remnant ink involves utilizing a pump inside the ink jet device to pump remnant ink of the ink gun, and then conveying the remnant ink into an ink storing zone via a pipeline. The ink storing zone is composed of a tubular hollow part and blotting cotton. The tubular hollow part has an opening for connecting the pipeline so that the pipeline can convey the remnant ink into the tubular hollow part. Then, the remnant ink is absorbed and stored by the blotting cotton disposed around the tubular hollow part. However, the said method increases the number of parts inside the ink jet device. Moreover, it is also necessary to add an extra engaging structure in the ink jet device to fix the tubular hollow part. This increases complication in assembly of the ink jet device.

### SUMMARY OF THE INVENTION

Therefore, the present invention provides an ink storage module to solve the problem mentioned above.

The present invention provides an ink storage module for storing remnant ink of an ink jet device comprising a base; a clamping structure connected to the base to create a monolithic structure, the clamping structure having at least one ink outlet; a pipeline having a first end connected to a pump for receiving remnant ink pumped by the pump, and a second end connected to the clamping structure in a detachable manner for conveying the remnant ink into the clamping structure; and a blotting structure installed on the base and disposed at a side of the ink outlet for absorbing the remnant ink.

The present invention further provides an ink jet device capable of storing remnant ink comprising an ink cartridge having an ink gun; a pump for pumping remnant ink of the ink gun; and an ink storage module comprising a base; a clamping structure connected to the base to create a monolithic structure, the clamping structure having at least one ink outlet; a pipeline having a first end connected to the pump for receiving remnant ink pumped by the pump, and a second end connected to the clamping structure in a detachable manner for conveying the remnant ink into the clamping structure; and a blotting structure installed on the base and disposed at a side of the ink outlet for absorbing the remnant ink.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an ink jet device according to the present invention.

FIG. 2 is an exploded diagram of an ink storage module in FIG. 1.

FIG. 3 is a diagram of a clamping structure in FIG. 2.

FIG. 4 is an assembly diagram of an ink storage module in FIG. 2.

FIG. 5 is a connection diagram of a base and a clamping structure according to another embodiment of the present invention.

### DETAILED DESCRIPTION

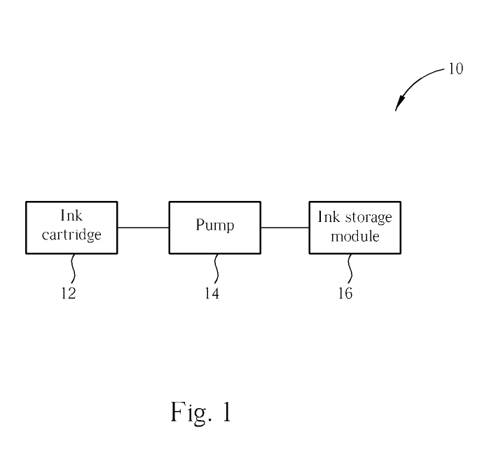

Please refer to FIG. 1. FIG. 1 is a functional block diagram of an ink jet device 10 according to the present invention. The ink jet device 10 comprises an ink cartridge 12, a pump 14, and an ink storage module 16. The ink cartridge 12 has an ink gun 18 (not shown in FIG. 1). The pump 14 is used for pumping remnant ink of the ink gun 18. The ink storage module 16 is used for storing the remnant ink pumped by the pump 14.

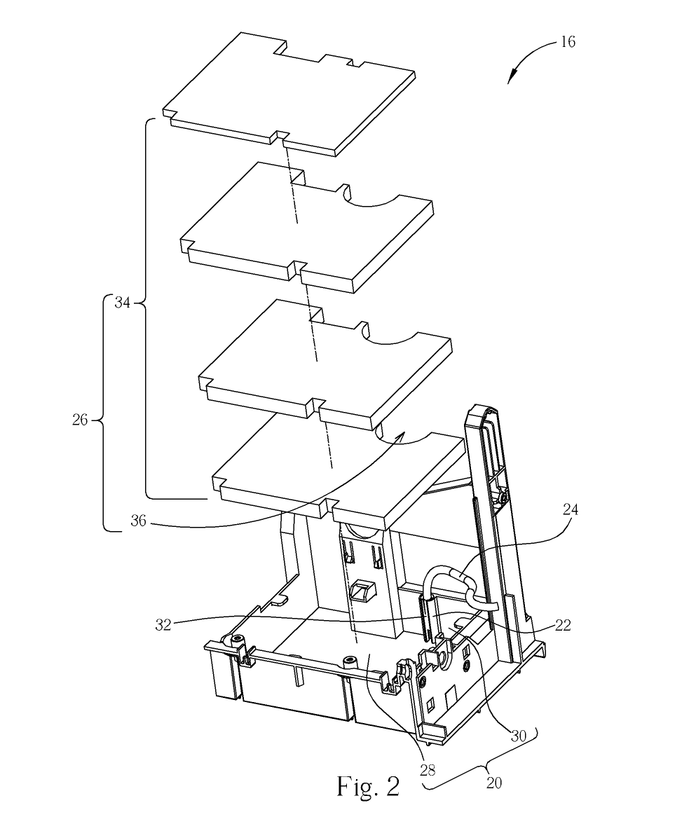

Please refer to FIG. 2. FIG. 2 is an exploded diagram of the ink storage module 16 in FIG. 1. The ink storage module 16 comprises a base 20, a clamping structure 22, a pipeline 24, and a blotting structure 26. The base 20 has a bottom plate 28 and an inner wall 30. As shown in FIG. 2, the clamping structure 22 is connected to the bottom plate 28 and the inner wall 30 of the base 20 to create a monolithic structure. Additionally, the clamping structure 22 has at least one ink outlet 32. The ink outlet 32 is an axial breach structure to lead the remnant ink to flow from the clamping structure 22 after flowing into the clamping structure 22. An end of the pipeline 24 is connected to the pump 14 for receiving the remnant ink pumped by the pump 14. Another end of the pipeline 24 is connected to the clamping structure 22 in a detachable manner for conveying the remnant ink into the clamping structure 22. The blotting structure 26 is installed on the base 20 and is disposed at a side of the ink outlet 32. The blotting structure 26 comprises a plurality of blotting pieces 34 for absorbing the remnant ink flowing from the clamping structure 22. The blotting structure 26 further has a recessed portion 36 for storing the remnant ink flowing from the clamping structure 22. The recessed portion 36 is composed of recessed breaches of the blotting pieces 34 to provide a buffer space for the blotting pieces 34 that absorb the remnant ink flowing from the clamping structure 22. That is to say, the blotting structure 26 not only can absorb the remnant ink flowing from the clamping structure 22 through the blotting pieces 34, but also can provide an independent storing space for storing the remnant ink flowing from the clamping structure 22 through the recessed portion 36.

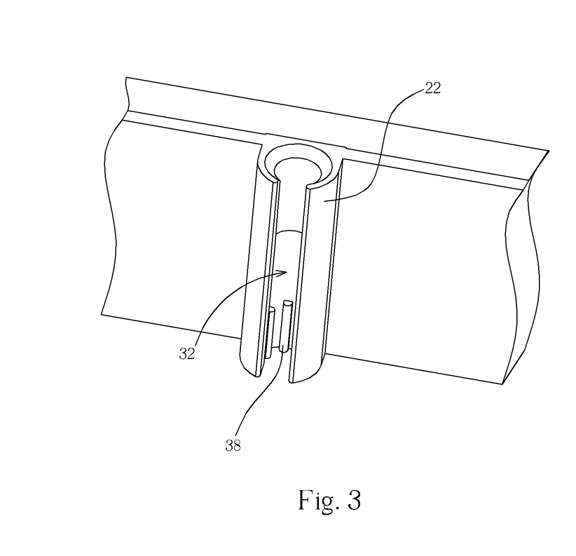

Please refer to FIG. 3. FIG. 3 is a diagram of the clamping structure 22 in FIG. 2. As shown in FIG. 3, the end of the clamping structure 22 connected to the pipeline 24 has a horn-shaped opening so that the pipeline 24 can be inserted into the clamping structure 22 more easily. Furthermore, the clamping structure 22 has a rib structure 38 disposed around the inside of the clamping structure 22 for fixing the position of the pipeline 24 when the pipeline 24 is inserted into the clamping structure 22. The position where the rib structure 38 is disposed is not limited to the bottom end of the clamping structure 22 shown in FIG. 3. That is to say, the rib structure 38 can also be disposed at other positions inside the clamping structure 22, such as a central zone inside the clamping structure 22. And, the rib structure 38 can comprise a plurality of ribs disposed around the inside of the clamping structure 22, or can be a continuous rib structure disposed around the inside of the clamping structure 22. It should be mentioned that design of the clamping structure 22 is not limited to the cylindraceous structure shown in FIG. 3. It can also be a taper tubular structure, such as a horn-shaped structure. That is to say, the end of the clamping structure 22 connected to the pipeline 24 has a smaller opening, and the other end has a larger opening. Therefore, the said design provides a larger space to increase the flow speed of the remnant ink. In addition, the clamping structure 22 can also be designed as any structure capable of clamping the pipeline 24. For example, as shown in FIG. 3, the ink outlet 32 of the clamping structure 22 is an axial breach structure. However, design of the axial breach structure is not limited to only the one axial breach shown in FIG. 3. The axial breach structure can also comprise a plurality of axial breaches disposed around the clamping structure 22 for increasing the speed of the remnant ink flowing from the clamping structure 22. In this way, the clamping structure 22 can be regarded as a splint clamping structure.

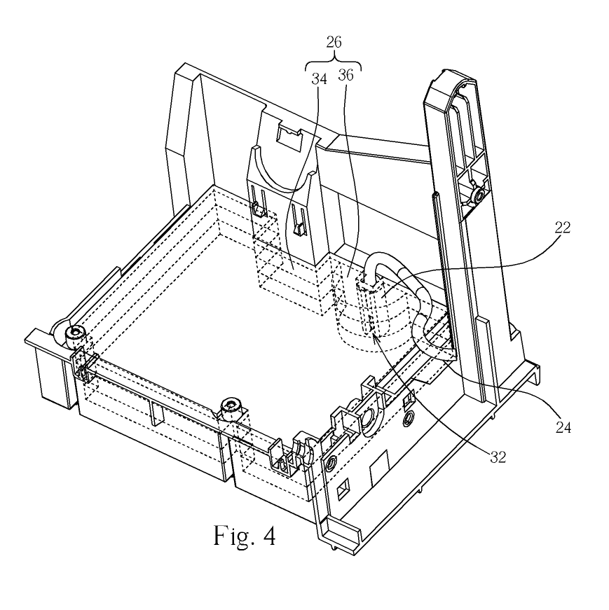

More detailed descriptions for the ink jet device 10 are given as follows. Please refer to FIG. 1 and FIG. 4. FIG. 4 is an assembly diagram of the ink storage module 16 in FIG. 2. After finishing cleaning the ink gun 18, the ink jet device 10 moves the ink cartridge 12 to the location where the pump 14 is disposed. Then, the pump 14 starts to pump the remnant ink out of the ink gun 18 for preventing build-up of the remnant ink. In the meanwhile, the remnant ink pumped by the pump 14 is conveyed to the end of pipeline 24 connected to the clamping structure 22 and is then conveyed into the clamping structure 22 via the pipeline 24. Finally, the pumped remnant ink flows from the ink outlet 32, and is then absorbed by the plurality of blotting pieces 34 or is stored in the storing space provided by the recessed portion 36.

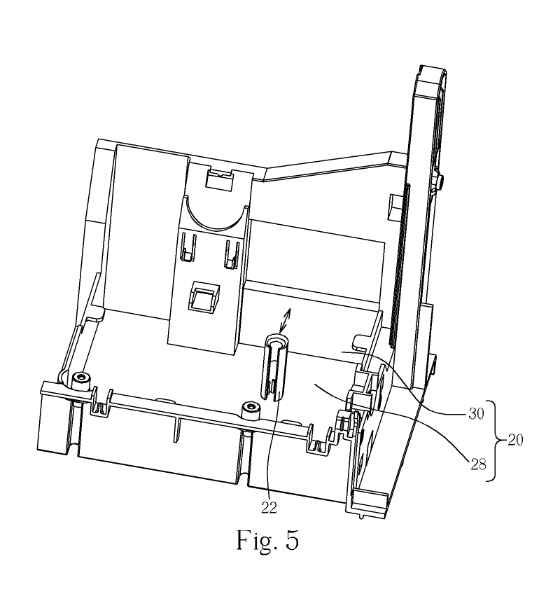

Furthermore, the connection of the base 20 and the clamping structure 22 is not limited to the configuration shown in FIG. 2. For example, please refer to FIG. 5. FIG. 5 is a connection diagram of the base 20 and the clamping structure 22 according to another embodiment of the present invention. As shown in FIG. 5, the clamping structure 22 can be only connected to the bottom plate 28 of the base 20 to create a monolithic structure. That is to say, the clamping structure 22 is located at a distance apart from the inner wall 30 of the base 20. In the same manner, the clamping structure 22 can be only connected to the inner wall 30 of the base 20 to create a monolithic structure. In other words, the clamping structure 22 is not connected to the bottom plate 28 of the base 20.

Compared with the prior art, the present invention combines the clamping structure and the base in a monolithic manner for reducing the number of parts inside the ink jet device and omitting the assembly of the tubular hollow part. In addition, according to the preferred embodiment of the present invention, the clamping structure is connected to the inner wall of the base. In such a manner, a user can insert the pipeline into the clamping structure easily. Therefore, the present invention provides a more convenient assembly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ink storage module for storing remnant ink of an ink jet device comprising:
a base;
a clamping structure connected to the base to create a monolithic structure, the clamping structure having at least one ink outlet;
a pipeline having a first end connected to a pump for receiving remnant ink pumped by the pump, and a second end connected to the clamping structure in a detachable manner for conveying the remnant ink into the clamping structure; and
a blotting structure installed on the base and disposed at a side of the ink outlet for absorbing the remnant ink.

2. The ink storage module of claim 1, wherein the blotting structure has a recessed portion for storing remnant ink flowing from the clamping structure.

3. The ink storage module of claim 1, wherein an end of the clamping structure connected to the pipeline has a horn-shaped opening.

4. The ink storage module of claim 1, wherein the clamping structure is a taper tubular structure.

5. The ink storage module of claim 1, wherein the clamping structure is a splint clamping structure.

6. The ink storage module of claim 1, wherein the clamping structure has a rib structure disposed around the inside of the clamping structure.

7. The ink storage module of claim 1, wherein the clamping structure is connected to an inner wall of the base.

8. The ink storage module of claim 1, wherein the clamping structure is connected to a bottom plate of the base.

9. The ink storage module of claim 1, wherein the ink outlet is an axial breach structure.

10. The ink storage module of claim 9, wherein the axial breach structure comprises a plurality of axial breaches disposed around the clamping structure.

11. The ink storage module of claim 1, wherein the blotting structure comprises a plurality of blotting pieces.

12. An ink jet device capable of storing remnant ink comprising:
an ink cartridge having an ink gun;
a pump for pumping remnant ink of the ink gun; and
an ink storage module comprising:
a base;
a clamping structure connected to the base to create a monolithic structure, the clamping structure having at least one ink outlet;
a pipeline having a first end connected to the pump for receiving remnant ink pumped by the pump, and a second end connected to the clamping structure in a detachable manner for conveying the remnant ink into the clamping structure; and
a blotting structure installed on the base and disposed at a side of the ink outlet for absorbing the remnant ink.

13. The ink jet device of claim 12, wherein the blotting structure has a recessed portion for storing remnant ink flowing from the clamping structure.

14. The ink jet device of claim 12, wherein an end of the clamping structure connected to the pipeline has a horn-shaped opening.

15. The ink jet device of claim 12, wherein the clamping structure is a taper tubular structure.

16. The ink jet device of claim 12, wherein the clamping structure is a splint clamping structure.

17. The ink jet device of claim 12, wherein the clamping structure has a rib structure disposed around the inside of the clamping structure.

18. The ink jet device of claim 12, wherein the clamping structure is connected to an inner wall of the base.

19. The ink jet device of claim 12, wherein the clamping structure is connected to a bottom plate of the base.

20. The ink jet device of claim 12, wherein the ink outlet is an axial breach structure.

21. The ink jet device of claim 20, wherein the axial breach structure comprises a plurality of axial breaches disposed around the clamping structure.

22. The ink jet device of claim 12, wherein the blotting structure comprises a plurality of blotting pieces.
